(19) United States
(12) Patent Application Publication
(10) Pub. No.: US 2010/0141731 A1
(43) Pub. Date: Jun. 10, 2010

(54) LINE PRINTER HEAD AND IMAGE FORMING APPARATUS INCLUDING THE SAME

(75) Inventors: Young-Chul KO, Yongin-si (KR); Woo-Kyu Kim, Suwon-si (KR); Shang-Hyeun Park, Yongin-si (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/535,266

(22) Filed: Aug. 4, 2009

(30) Foreign Application Priority Data
Dec. 8, 2008 (KR) 10-2008-0124298

(51) Int. Cl. B41J 2/435

(52) U.S. Cl. 347/247

(57) ABSTRACT

Disclosed is a line printer head that exposes an object, e.g., a photoconductor body, of an image forming apparatus. The line printer head includes multiple light emitting devices in a linear arrangement along a main scanning direction. Each light emitting device includes a light emitting region, a first electrode on a lower portion of the light emitting region, a second electrode on an upper portion of the light emitting region and an optical waveguide disposed above the second electrode and configured to guide light generated by the light emitted region such that the light is output through an opening of the optical waveguide. The integrated circuit is configured to drive the light emitting devices and has multiple output terminals, each of which is connected to the first electrode of the respective corresponding one of the light emitting devices. The light emitting devices and the integrated circuit are formed on the same substrate.

### CROSS-REFERENCE TO RELATED PATENT APPLICATION

This application claims the benefit of Korean Patent Application No. 10-2008-0124298, filed on Dec. 8, 2008, in the Korean Intellectual Property Office, the disclosure of which is incorporated herein by reference in its entirety.

### TECHNICAL FIELD

The present disclosure generally relates to a line printer head, and an image forming apparatus employing the line printer head as an exposure device.

### BACKGROUND OF RELATED ART

Broadly speaking, an image forming apparatus using an electro-photographic method forms an image by having an electrostatic latent image formed on a surface of an image carrier, generating a developed image by developing the electrostatic latent image using developer (e.g., toner), transferring the generated developed image to a printing medium, and then fixing the transferred developed image to the printing medium.

In a laser printer, which is an example of such an image forming apparatus, an image pattern is formed on an image carrier, such as a photoconductive drum, for example, by irradiating a laser beam emitted by a laser diode using a polygonal mirror.

More recently, the use of a line printer head capable of forming an electrostatic latent image on a surface of a photoconductive drum in units of lines has been suggested. There have also been attempts to apply an electroluminescent device to such a line printer head.

### SUMMARY OF THE DISCLOSURE

According to one aspect of the present disclosure, there is provided a line printer head for exposing an object in an image forming apparatus. The line printer head may include a substrate on which a multiple light emitting devices and an integrated circuit may be formed. The light emitting devices may be arranged in a linear arrangement along a main scanning direction of the image forming apparatus. Each light emitting device may include a light emitting region configured to generate light, a first electrode disposed on a lower portion of the light emitting region, a second electrode disposed on an upper portion of the light emitting region and an optical waveguide disposed above the second electrode. The second electrode may be configured to allow therethrough transmission of the light generated by the light emitting region. The optical waveguide may be configured to receive the light generated by the light emitted region, and to guide the light to output through an output opening defined on the optical waveguide. The integrated circuit may be configured to drive the light emitting devices. The integrated circuit may have a plurality of output terminals, each of which is connected to the first electrode of a respective corresponding one of the plurality of light emitting devices.

The second electrodes of the light emitting devices may be connected to each other form a common electrode.

The output opening of the optical waveguide may be defined on an outer surface at one of an upper portion of the optical waveguide and a side portion of the optical waveguide.

The light emitting region may include an inorganic electroluminescent structure.

The inorganic electroluminescent structure may be a thin film multilayer structure that includes a first insulation layer, an inorganic light emitting layer disposed on the first insulating layer and a second insulation layer disposed on the inorganic light emitting layer.

The integrated circuit may include circuitry made of a metal-oxide-semiconductor (MOS) process.

According to another aspect, an image forming apparatus may be provided to include an object to be exposed with light, a line printer head that may be configured to form an electrostatic latent image on the object by radiating light to the object along a main scanning direction and a developer unit. The line printer head may comprise, and may comprise a plurality of light emitting devices and an integrated circuit each formed on a substrate. The developer unit may be configured to develop the electrostatic latent image into a visible toner image by supplying toner to the electrostatic latent image formed on the object. The plurality of light emitting devices may be arranged in a linear arrangement corresponding to a main scanning direction. Each of the plurality of light emitting devices may include a light emitting region configured to generate light, a first electrode disposed on a lower portion of the light emitting region, a second electrode disposed on an upper portion of the light emitting region and an optical waveguide disposed above the second electrode. The second electrode may be configured to allow therethrough transmission of the light generated by the light emitting region. The optical waveguide may be configured to receive the light generated by the light emitted region, and to guide the light to output through an output opening defined on the optical waveguide. The integrated circuit may be configured to drive the plurality of light emitting devices, the integrated circuit having a plurality of output terminals, each of which being connected to the first electrode of a respective corresponding one of the plurality of light emitting devices.

The second electrodes of the plurality of light emitting devices may be connected to each other to form a common electrode.

The output opening of the optical waveguide may be defined on an outer surface at one of an upper portion of the optical waveguide and a side portion of the optical waveguide.

The light emitting region may include an inorganic electroluminescent structure.

The inorganic electroluminescent structure may be a thin film multilayer structure including a first insulation layer, an inorganic light emitting layer disposed on the first insulating layer and a second insulation layer disposed on the inorganic light emitting layer.

The integrated circuit may include circuitry made of a metal-oxide-semiconductor (MOS) process.

According to yet another aspect, a line printer head may be provided to include a plurality of light emitting devices formed on a semiconductor substrate and an integrated circuit formed on the semiconductor substrate. The plurality of light emitting devices may be arranged in a linear arrangement corresponding to a main scanning direction. Each of the plurality of light emitting devices may have a light emitting element, a first electrode configured to reflect light and a second electrode configured to transmit light. The light emitting element may be configured to generate light in response to a current received through the first and the second electrodes. The second electrodes of the plurality of light emitting devices may be connected to each other. The integrated circuit may be configured to drive the plurality of light emitting devices, and may have a plurality of output terminals, each of which may be connected to the first electrode of a respective corresponding one of the plurality of light emitting devices.

The integrated circuit may be formed on the semiconductor substrate, the plurality of light emitting devices being formed on the semiconductor substrate above the integrated circuit.

Each of the plurality of light emitting devices may include a light emitting region made of an inorganic electroluminescent material.

Each of the plurality of light emitting devices may include an optical waveguide disposed above the second electrode. The optical waveguide may be configured to receive the light generated by the light emitting element, and to guide the light toward a light exiting opening of the optical waveguide, through which the light exits the optical waveguide.

The optical waveguide may comprise a transparent body covering the second electrode and a reflective layer covering the transparent body such that the reflective layer defines the light exiting opening.

The transparent body may be formed of a photoresist selected from a group comprising SU-8, poly-methylmethacrylate (PMMA) and poly-dimethylsiloxane (PDMS).

The reflective layer may be formed of aluminum.

### BRIEF DESCRIPTION OF THE DRAWINGS

Various features and advantages of the present disclosure will become more apparent from several embodiments thereof described herein with reference to the attached drawings, in which:

FIG. 1 is a perspective view schematically illustrating a line printer head according to an embodiment of the present disclosure;

FIG. 2 is a block diagram schematically illustrating a driving integrated circuit of the line printer head of FIG. 1;

FIG. 3 is a cross-sectional view illustrating the structure of the line printer head of FIG. 1 in which the driving integrated circuit and a plurality of light emitting devices are formed on a common substrate according to an embodiment of the present disclosure;

FIG. 4 is a perspective view illustrating the structure of a driving integrated circuit and light emitting devices formed on a common substrate according to an embodiment of the present disclosure;

FIG. 5 is a cross-sectional view taken along a line I-I of FIG. 4;

FIG. 6 is a cross-sectional view taken along a line II-II of FIG. 4;

FIGS. 7A through 7F are cross-sectional views illustrative of a method of manufacturing the light emitting device according to an embodiment of the present disclosure;

FIG. 8 is a cross-sectional view illustrating a light emitting device according to another embodiment of the present disclosure;

FIG. 9 is a cross-sectional view illustrating a light emitting device according to another embodiment of the present disclosure;

FIG. 10 is a perspective view illustrating a light emitting device according to another embodiment of the present disclosure;

FIG. 11 is a diagram schematically illustrating an image forming apparatus employing a line printer head according to an embodiment of the present disclosure; and

FIG. 12 is a perspective view illustrating a line printer head and a photoconductive drum usable in an image forming apparatus according to an embodiment of the present disclosure.

### DETAILED DESCRIPTION OF SEVERAL EMBODIMENTS

Reference will now be made in detail to several embodiment, examples of which are illustrated in the accompanying drawings, wherein like reference numerals refer to like elements throughout. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should also be noted that in the drawings, the dimensions of the features are not intended to be to true scale and may be exaggerated for the sake of allowing greater understanding. Repetitive description with respect to like elements of different embodiments may be omitted for the sake of brevity.

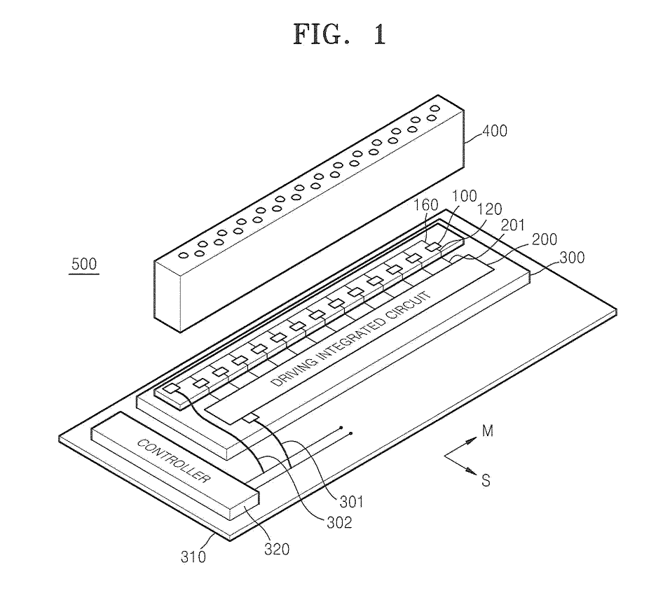

FIG. 1 is a perspective view that schematically illustrates a line printer head 500 according to an embodiment of the present disclosure. Referring to FIG. 1, the line printer head 500 can include multiple light emitting devices 100 arranged or configured in a main scanning direction on a substrate 300, a driving integrated circuit 200 formed on the substrate 300 and configured to drive the light emitting devices 100. Moreover, the line printer head 500 can include an image forming optical system 400 configured to concentrate light radiated from light emitting devices 100 on the object to be exposed.

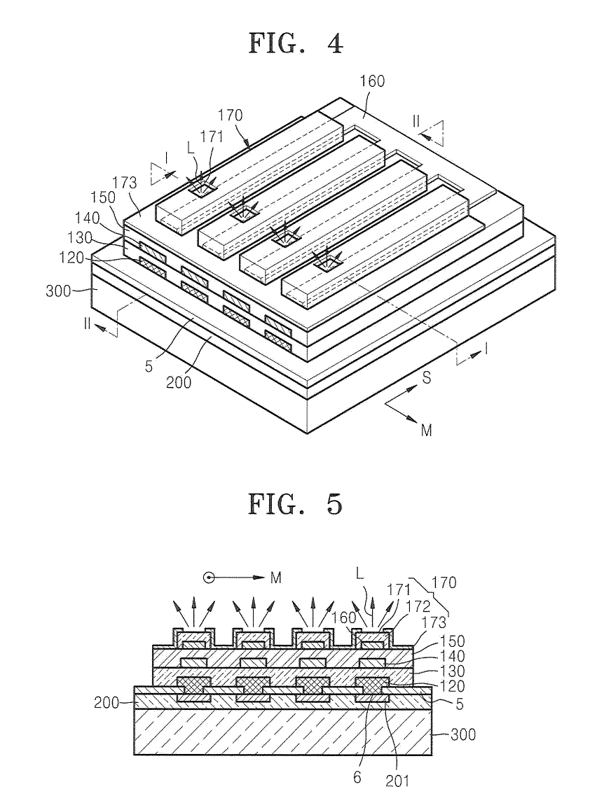

FIGS. 3 and 4 are respectively a cross-sectional view and a perspective view illustrating the relevant structure of the line printer head 500 in which the driving integrated circuit 200 and the light emitting devices 100 are formed on the substrate 300 according to an embodiment of the present disclosure. Referring to FIG. 3, each of the light emitting devices 100 can include a light emitting layer 140, a lower electrode 120, and an upper electrode 160. The upper electrodes 160 of the light emitting devices 100 can be connected to each other to form a common electrode, and the lower electrodes 120 of the light emitting devices 100 can be individual electrodes. Each lower electrode 120 can be connected to one of the multiple output terminals 201 of the driving integrated circuit 200.

The substrate 300, on which the light emitting devices 100 and the driving integrated circuit 200 are formed, can be disposed on a printed circuit board 310, for example. A controller 320 can include circuitry configured to receive information associated with one or more input signals, such as an image signal for printing an image, for example, to drive the light emitting devices 100, and may be configured to convert such information to a data signal that operates the driving integrated circuit 200. In some embodiments, the controller 320 can be configured to provide one or more data signal to the driving integrated circuit 200 along with a control signal, such as a clock signal, for example. The data signal and the control signal can be provided to the driving integrated circuit 200 via a connection 301 (see FIG. 1). Another connection, connection 302, for example, can provide a scanning line signal to the upper electrodes 160 of the light emitting devices 100, wherein the upper electrodes 160 arc configured to form a common electrode. The connections 301 and 302 can be, for example, wiring structures formed on the printed circuit board 310.

The image forming optical system 400 can be a SELFOC lens array (SLA), for example. As described below, the image forming optical system 400 can be disposed between the object to be illuminated and the line printer head 500. The image forming optical system 400 can be detachable from the line printer head 500 or can be assembled as single unit (e.g., integrated) with the line printer head 500.

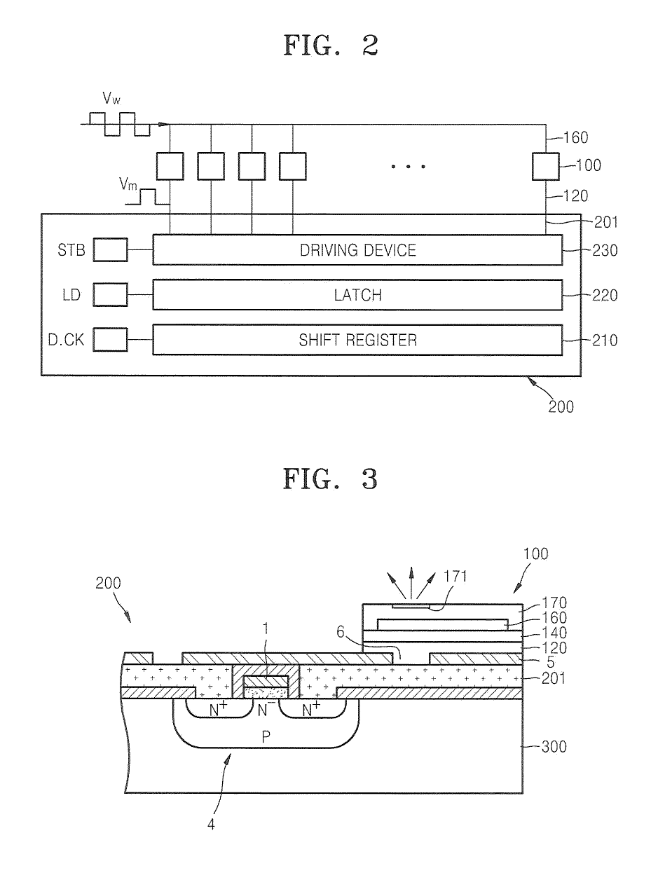

The driving integrated circuit 200 can include circuitry configured to supply a driving signal sequentially to the light emitting devices 100. FIG. 2 is a block diagram that schematically illustrates the driving integrated circuit 200 according to an embodiment of the present disclosure. Referring to FIG. 2, a shift register 210 can be synchronized with a clock signal, CK, by, for example, using a data signal, D, to generate a driving signal associated with each of the light emitting devices 100. The driving signals to the light emitting devices 100 can be transmitted to a latch 220, which is configured to operate according to a data loading signal, LD, and to the output terminals 201 via a driving device 230 as a driving voltage. The driving device 230 can include multiple gate devices respectively connected to the multiple terminals 201, and may be configured to receive a strobe signal, STB, as an input.

The scanning line signal applied to the upper electrodes 160 can be, for example, a pulse signal having a pulse width corresponding to a time interval during which light is emitted by the light emitting devices 100 and an amplitude V_{W} corresponding to a threshold voltage for operating the light emitting devices 100. The driving voltage, which is provided via the output terminals 201 of the driving integrated circuit 200, can be applied to the lower electrodes 120 of the light emitting devices 100. The driving voltage can have an amplitude Vm corresponding to a desired light emitting intensity so that the light emitting devices 100 emit light having the desired light emitting intensity. Thus, in the light emitting devices 100 to which the driving voltage is applied from the driving integrated circuit 200, a voltage having an amplitude equal to or greater than the amplitude of the threshold voltage is applied between the lower and upper electrodes 120 and 160 for the light emitting layer 140 of FIG. 3 to emit light. The structure of the driving integrated circuit 200 illustrated in FIG. 2 is only one embodiment, and the present disclosure need not be limited to that particular embodiment.

When the driving integrated circuit 200 and the multiple light emitting devices 100 are formed on different substrates, and then separately mounted on the printed circuit board 310, the number of wire bondings that may be required to connect the driving integrated circuit 200 and the light emitting devices 100 can be at least the same as the number of light emitting devices 100. For example, when a line printer head having a resolution of 600 dots-per-inch (dpi) for an A4 size is to be made, thousands of light emitting devices 100 and corresponding wire bondings may be necessary. Such a large quantity of wire bondings may cause interference between wires, and may increase production costs because of the long process time required to attach or bond the wires. Moreover, manufacturing a line printer head having high resolution may be difficult because of the technical limitations in the realizable distances between the wires.

In the line printer head 500, the driving integrated circuit 200 and the light emitting devices 100 can be formed on the same substrate 300 with the lower electrodes 120 of the light emitting devices 100 electrically connected to the output terminals 201 of the driving integrated circuit 200. In such an embodiment, bonding of individual wires for connecting the lower electrodes 120 and the output terminals 201 becomes unnecessary, resulting a reduction of the processing cost and/or complexity of the assembling of the driving integrated circuit 200 and the light emitting devices 100 on the same substrate 300. Moreover, because problems arising from the reduced distance, or interference, between wires may become less likely, the line printer head 500 can be manufactured to have a high resolution.

The driving integrated circuit 200 can be made in many and various ways. By way of an illustrative example, a driving element 4 based on a metal-oxide-semiconductor (MOS) structure disposed at an output stage of the driving integrated circuit 200 is illustrated in FIG. 3. Because the MOS structure is well known to one of ordinary skill in the art, for brevity, only a general structure is shown in FIG. 3. In the MOS-based driving element 4, a source area (N+) and a drain area (N+), which are area with a high impurity concentration, are formed by doping impurity into the substrate 300. The substrate 300 can be a P-type silicon (Si) semiconductor substrate, for example. In the MOS-based driving element 4, a channel area can be made between the source area and the drain area by forming a low concentration impurity area (N−) through a diffusion process, for example. The MOS-based driving element 4 can be a type of driving switch that controls an output of the output terminal 201 according to a current that flows through the channel area that in turn changes according to a voltage applied to a gate electrode 1.

An insulation layer 5 can be disposed on the output terminal 201, and the lower electrode 120 can be disposed on the insulation layer 5. In one embodiment, the lower electrode 120 can be electrically connected to the output terminal 201 by filling an opening 6 defined in the insulating layer 5 with the material used for forming the lower electrode 120, for example. In another embodiments, a conductive material can be filled in the opening 6 before forming the lower electrode 120, and then the lower electrode 120 can be dispose on the conductive material in the opening 6. The light emitting layer 140, the upper electrode 160, and an optical waveguide unit 170 can be sequentially disposed or stacked on the lower electrode 120, in that order. As illustrated in FIG. 4, the upper electrodes 160 of the light emitting devices 100 can be connected to each other so that a common scanning line signal may be applied.

Because a process of manufacturing a gallium arsenide (GaAs) light emitting diode (LED) includes doping and activating processes performed at a temperature close to about 1000 degrees Celsius (° C.), such a process may not be compatible with a process of manufacturing the MOS-based structures in the driving integrated circuit 200 in which a diffusion temperature is close to about 1000° C. Thus, a light emitting device having an inorganic thin film electroluminescent (TEEL) structure may be used as the light emitting device 100. Because a manufacturing process temperature of a light emitting device having an inorganic TEEL structure is about 250° C. or less, a light emitting device having an inorganic TEEL, structure can be compatible with a process of manufacturing the driving integrated circuit 200. It should be noted however that GaAs LEDs could be employed if a fabrication process other than the MOS-based process that is compatible with or that can withstand the high processing temperature for GaAs is also employed for the fabrication of the driving integrated circuit 200.

A detailed structure and a process of manufacturing a light emitting device having an inorganic TEEL, structure is described below. The present disclosure is not limited to a structure of the driving integrated circuit 200 and a process of manufacturing the driving integrated circuit 200 is well known to one of ordinary skill in the art. Thus, descriptions of the manufacturing process and the detailed structure of the driving integrated circuit 200 are not included herein.

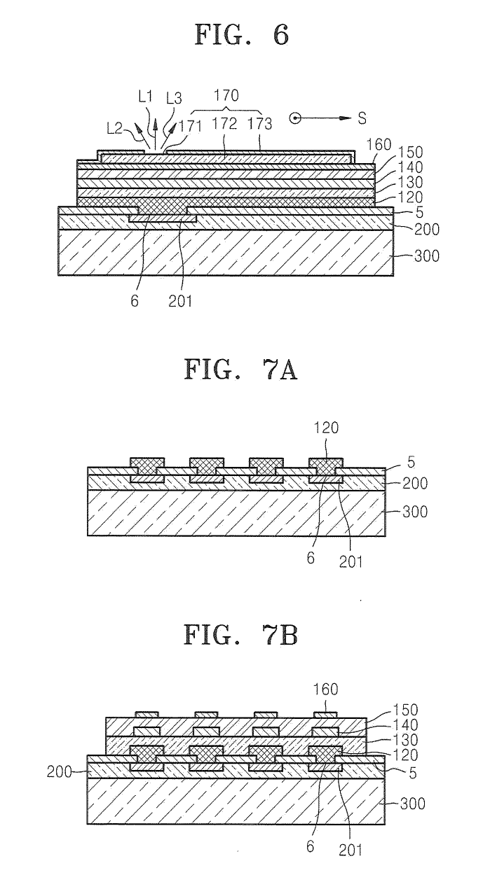

FIG. 5 is a cross-sectional view of taken along a line I-I of FIG. 4, and FIG. 6 is a cross-sectional view taken along a line II-II of FIG. 4. In FIGS. 4-6, for brevity, the driving integrated circuit is not illustrated and only the openings 6 for electrically connecting the lower electrodes 120 to the output terminals 201 of the driving integrated circuit are shown. In FIGS. 4 and 5, only 4 light emitting devices 100 are illustrated by way of example.

Referring to FIGS. 4-6, each of the light emitting devices 100 can have an inorganic TEEL structure including the lower electrode 120, a lower insulation layer 130, the inorganic light emitting layer 140, an upper insulation layer 150, and the upper electrode 160.

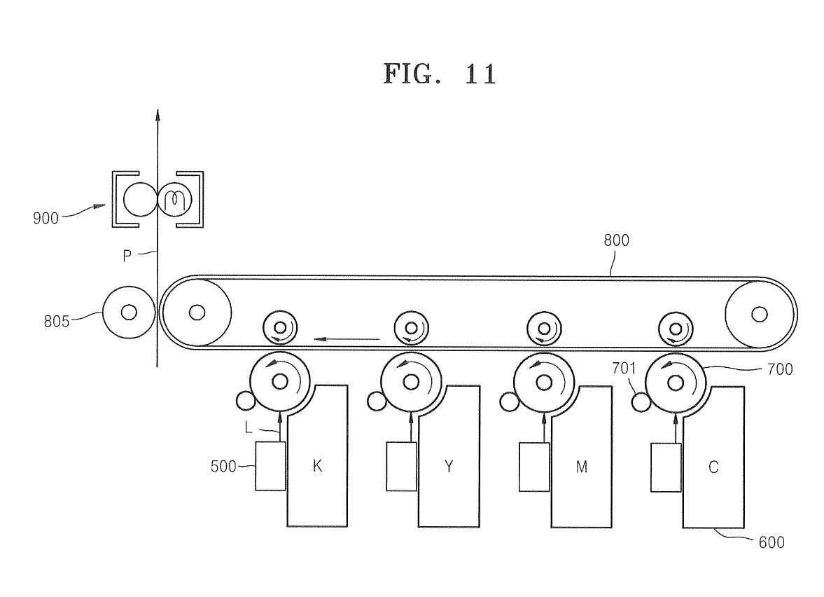

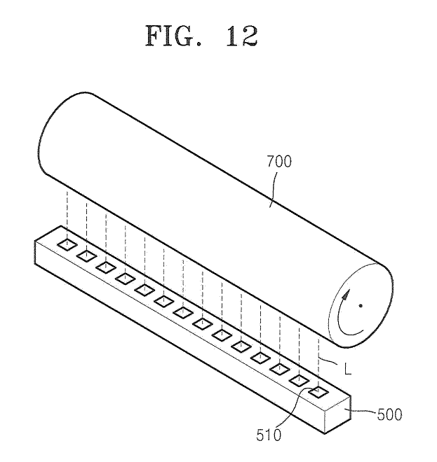

The lower electrode 120 can be a reflective electrode made of a conductive material having high reflectance characteristics, such as aluminum (Al) or silver (Ag), for example. As described above, the lower electrode 120 can be an individual electrode electrically connected to the output terminal 201 of the driving integrated circuit 200 via the opening 6. The upper electrode 160 (partially shown in dashed lines in FIG. 4) can be a transmissive electrode made of a conductive material having high optical transmittance, such as, for example, indium tin oxide (ITO), and can form a common electrode with the other upper electrodes 160 as illustrated in FIG. 4. The upper electrode 160 can be used to define a light emitting area. The light emitting area can be expanded by extending the upper electrode 160 in a sub-scanning direction S, while maintaining an arrangement distance between the upper electrodes 160 in a main scanning direction M. The main scanning direction M can correspond to a longitudinal direction of an object to be exposed as described below with reference to FIGS. 11 and 12, and the sub-scanning direction S can correspond a direction perpendicular to the main scanning direction M (see FIG. 4).

The lower and upper insulation layers 130 and 150 may each be formed of various dielectric materials, such as, for example, yttrium oxide (Y₂O₃), Ba₂O₃, aluminum oxide (Al₂O₃) and silicon oxide (SiO₂), which may have good withstanding voltage (e.g., high breakdown voltage) characteristics. The inorganic light emitting layer 140 can be made of an inorganic electroluminescent material, and can be configured to emit light by electron excitation of the inorganic electroluminescent material resulting from the collision of electrons accelerated in an electric field. Examples of inorganic electroluminescent materials include a metal sulfide, such as, zinc sulfide (ZnS), strontium sulfide (SrS), or calcium sulfide (CaS), for example, an alkali earth sulfide compound, such as, CaGa₂S₄ or SrGa₂S₄, for example, and a transition metal or alkali rare-earth metal, such as, manganese (Mn), cerium (Ce), terbium (Tb), europium (Eu), thulium (Tm), erbium (Er), praseodymium (Pr), or lead (Pb).

Because the lower electrode 120 of each of the light emitting devices 100 is an individual electrode, the lower insulation layer 130 can isolates the lower electrodes 120 from each other as illustrated in FIGS. 5 and 6. The inorganic light emitting layers 140 can be isolated from each other by the upper insulation layer 150 as illustrated in FIGS. 5 and 6, but the isolation of the lower electrodes 120 and the inorganic light emitting layers 140 need not be limited to being isolated by the lower insulation layer 130 and the upper insulation layer 150, respectively.

The optical waveguide unit 170 can be configured to guide light generated in the inorganic light emitting layer 140, and to transmit the light to an optical output unit 171 having an opening. The optical waveguide unit 170 can include a transparent body 172 and a reflective layer 173. The reflective layer 173 can be dispose on the upper and side portions of the transparent body 172, except where the optical output unit 171 is formed.

The transparent body 172 can be configured to cover the upper electrode 160. Because the upper electrode 160 can have a substantially rectangular shape extending in the sub-scanning direction S, the transparent body 172 can also have a substantially rectangular shape extending in the sub-scanning direction S. The transparent body 172 can be made of a polymer having good permeability properties, for example. As described below, the transparent body 172 can be made by using a photolithographic process or by an imprinting process. The transparent body 172 can be made of a photoresist such as SU-8, poly-methylmethacrylate (PMMA), or poly-dimethylsiloxane (PDMS), for example.

The optical output unit 171 can be arranged on the optical waveguide unit 170. In one embodiment, the multiple output units 171 can be configured or arranged in a single row along the main scanning direction M. In other embodiments, however, the optical output units 171 can be configured or arranged into two or more rows along the main scanning direction M.

The reflective layer 173 can be made of a metal having good reflective characteristics, such as aluminum (Al), for example.

When a voltage is applied to the lower electrode 120 and the upper electrode 160, electrons in the inorganic light emitting material of the inorganic light emitting layer 140 can be excited before stabilizing according to the acceleration collision of electrovalence such that the inorganic light emitting layer 140 emits light. The light emitted by the inorganic light emitting layer 140 can travel directly to the upper electrode 160 or can travel to the upper electrode 60 after being reflected by the lower electrode 120. The optical waveguide unit 170 can be configured to guide the light generated from the inorganic light emitting layer 140 in such a manner as to direct the light toward the optical output unit 171. A portion of the light emitted by the inorganic light emitting layer 140 (L1) can be directly irradiated to the optical output unit 171, and other portion of the light (L2 and L3) can be reflected by the lower electrode 120 and/or the reflective layer 173 before being irradiated to the optical output unit 171. A portion of light may be lost by repeated reflections between the lower electrode 120 and the reflective layer 173, but the amount of light lost is typically a small portion of the light emitted by the inorganic light emitting layer 140. Thus, most of the light emitted by the inorganic light emitting layer 140 is irradiated to the optical output unit 171.

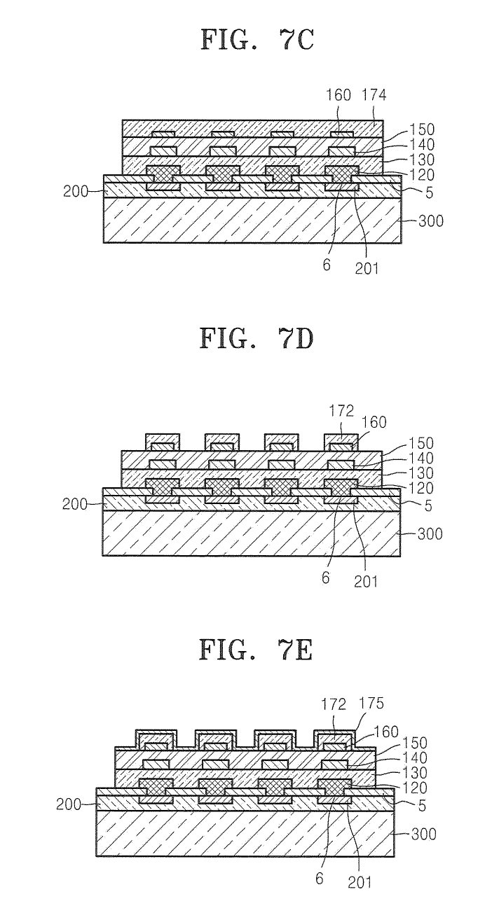

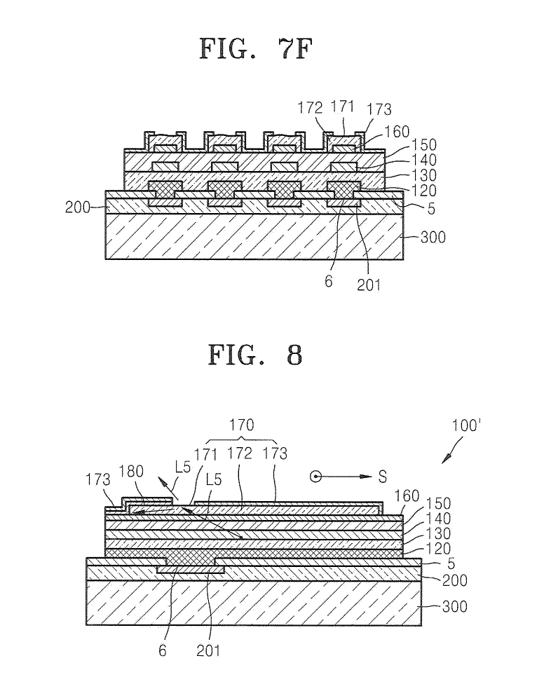

FIGS. 7A-7F are cross-sectional views illustrative of a method of manufacturing the light emitting device 100 illustrated in FIG. 4 according to an embodiment of the present disclosure. For brevity, a detailed structure of the driving integrated circuit 200 is not illustrated in FIGS. 7A-7F.

Referring to FIG. 7A, the driving integrated circuit 200 can be disposed on the substrate 300. The insulation layer 5 including the opening 6 can be disposed on the driving integrated circuit 200 using a photolithographic process or other like patterning process, for example. The lower electrode 120, which can fill the opening 6 when being formed, can be made of a conductive material having excellent reflectivity, such as aluminum or silver, for example, that is deposited using a suitable mask. In some embodiments, a conductive material can be deposited into the opening 6 to fill the opening 6 before the lower electrode 120 is formed. As a result, the lower electrode 120 can be connected to the output terminal 201 of the driving integrated circuit 200 through the opening 6.

As illustrated in FIG. 7B, the lower insulation layer 130, the inorganic light emitting layer 140, the upper insulation layer 150 and the upper electrode 160 can be sequentially formed on the lower electrode 120, in that order. As illustrated in FIG. 4, the upper electrodes 160 can be connected to each other.

FIG. 7C illustrates a photoresist layer 174 disposed over the upper insulation layer 150 and the upper electrode 160. The photoresist layer 174 can be made of a material having good optical transmissive or transmittance properties such as, photoresist SU-8, for example. As illustrated in FIG. 7D, the transparent body 172 of the optical waveguide unit 170 can be made by removing portions of the photoresist layer 174 between the upper electrodes 160 by using, for example, a photolithographic process. As shown in FIG. 7E, a metal layer 175 can be formed by depositing a metal having good reflectivity, such as, aluminum, for example, on the transparent bodies 172 and the upper insulation layer 150. FIG. 7F shows the reflective layer 173 that includes the optical output unit 171 having an opening formed by removing a portion of the metal layer 175 in predetermined areas using the photolithographic process, for example.

The method described with reference to FIGS. 7A-7F is only an embodiment, and the present disclosure need not be limited thereto. For example, the reflective layer 173, including the optical output unit 171 illustrated in FIG. 7F can be directly formed from the step illustrated in FIG. 7D, by using a shadow mask method, for example. Moreover, the transparent body 172 can be made using an imprinting method. The transparent body 172 can be made by coating a polymer having good optical transmittance properties, such as, for example, PMDS or PMMS, on an inorganic TEEL structure including the lower electrode 120, the lower insulation layer 130, the inorganic light emitting layer 140, the upper insulation layer 150, and the upper electrode 160, preparing a mask having an inverse image of the transparent body 172 using a photolithographic process or the like, and removing portions of the coated polymer by using the prepared mask.

FIG. 8 is a cross-sectional view illustrating a light emitting device 100′ according to another embodiment of the present disclosure. The light emitting device 100′ of FIG. 8 can be substantially the same as the light emitting device 100 illustrated in FIGS. 4-6, except that a light absorption member 180 is further provided. Accordingly, the same reference numerals are used for the same elements, and descriptions thereof are simplified or are not repeated.

Referring to FIG. 8, the light absorption member 180 can be a layer configured to absorb light and can be disposed on a portion of the inner surface of the reflective layer 173 of the optical waveguide unit 170. The light absorption member 180 can be made of a coating agent including a coloring composition that can absorb light, but a material of the light absorption member 180 need not be limited thereto. When a voltage is applied to the lower electrode 120 and the upper electrode 160, light can be generated by the light emitting layer 140. Most of the generated light can be emitted via the optical output unit 171, however, some of the light may be trapped and not emitted. The light may be trapped between, for example, the lower electrode 120 and the reflective layer 173 because of continuous total reflection or general reflection. Such trapped light may end up being irradiated to an unintended area of the object being illuminated, which may result in, for example, ghost spots on a photoconductor. The light absorption member 180 can be configured to absorb such trapped light.

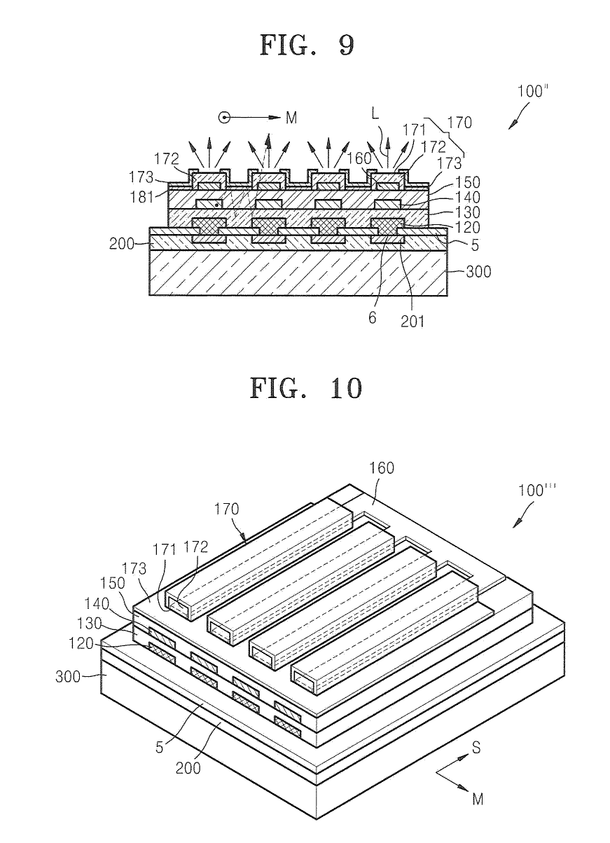

FIG. 9 is a cross-sectional view illustrating a light emitting device 100″ according to another embodiment of the present disclosure. The light emitting device 100″ of FIG. 9 can be substantially the same as the light emitting device 100 illustrated in FIGS. 4-6, except that a light absorption member 181 is further provided. Accordingly, the same reference numerals are used for the same elements, and descriptions thereof are simplified or are not repeated.

Referring to FIG. 9, the light absorption member 181 can be a layer configured to absorb light, and may be disposed between the transparent bodies 172, which are spaced apart from each other along a main scanning direction M. The light absorption member 181 can be disposed between the upper insulation layer 150 and the reflective layer 173, for example. The light absorption member 181 can be made of a coating agent including a coloring composition that can absorb light, but a material of the light absorption member 181 need not be limited thereto. When a voltage is applied to the lower electrode 120 and the upper electrode 160, light can be generated by the inorganic light emitting layer 140. Most of the light (L) generated by the light emitting layer 140 can be emitted through the optical output unit 171. Some of the light generated, however, can be totally reflected or generally reflected between the lower electrode 120 and the reflective layer 173. Such light is not irradiated to the optical output unit 171 of the upper electrode 160 to which the voltage is applied, but can instead be irradiated to another adjacent optical output unit 171, which may result in a crosstalk. The light absorption member 181 can be configured to absorb the light irradiated to an adjacent optical output unit 171.

In the above-described embodiments, a light emitting device having an inorganic TEEL structure can be used as the light emitting devices 100, 100′ and 100″ while a MOS-based driving integrated circuit can be used as the driving integrated circuit 200. The present disclosure, however, need not be limited thereto. The light emitting device and the driving integrated circuit can have various implementations as long as the processes used to manufacture the light emitting device and the driving integrated circuit can be compatible processes. For example, any driving integrated circuit based on another integrated circuit element, instead of one based on a MOS structure, can be used, and a light emitting device having a thick dielectric electroluminescent structure or an organic electroluminescent structure can be used along with an LED-based light emitter.

FIG. 10 is a perspective view illustrating a light emitting device 100′″ according to another embodiment of the present disclosure. The light emitting device 100′″ of FIG. 10 can be substantially the same as the light emitting device 100 illustrated in FIG. 4, except that the optical output unit 171 that defines the light emission area is provided as a side emission type optical output unit arranged on a side of the optical waveguide unit 170.

FIG. 11 is a diagram schematically illustrating an image forming apparatus employing the line printer head 500 according to an embodiment of the present disclosure. FIG. 12 is a perspective view illustrating the line printer head 500 and a photoconductive drum 700 of the image forming apparatus of FIG. 11.

Referring to FIG. 11, the image forming apparatus according to an embodiment may include the line printer head 500, a developing unit 600, a photoconductive drum 700, a charging roller 701, an intermediate transferring belt 800, a transferring roller 805 and a fixing unit 900.

The line printer head 500 can be consistent with one or more of the above-described embodiments and modifications hereof, and can be configured to radiate light L to the photoconductive drum 700. The light L produced by the line printer head 500 can have substantially a linear shape, and can be modulated according to image information. The photoconductive drum 700 is an example of a photoconductor and can be made by disposing a photoconductive layer having a predetermined thickness around the circumference of a cylindrical metal pipe, for example. The circumferential surface of the photoconductive drum 700 can correspond to an object to be exposed referenced above, on which an electrostatic latent image may be formed as a result of the irradiation of the light L by the line printer head 500. In some embodiments, a photoconductive belt having a belt shape can alternatively be used as the photoconductor. The charging roller 701 is an example of a charger configured to charge a surface of the photoconductive drum 700 with a uniform electrical potential by rotating in contact with the photoconductive drum 700. A charging bias can be applied to the charging roller 701 to charge the surface of the photoconductive drum 700. In some embodiments, a corona charger (not shown) can be used instead of the charging roller 701. The developing unit 600 can be configured to contain toner that is moved to the photoconductive drum 700 by the application of a developing bias between the developing unit 600 and the photoconductive drum 700 to develop the electrostatic latent image into a visible toner image. The toner image formed on the photoconductive drum 700 can be transferred to the intermediate transferring belt 800. The toner image can be transferred to a paper P that passes between the transferring roller 805 and the intermediate transferring belt 800 based on a transferring bias applied to the transferring roller 805. The toner image transferred to the paper P can be fixed to the paper P via heat and pressure from the fixing unit 900 to form the image. In some embodiments, the paper P could be routed to contact each of the photoconductive drums 700 such that the toner images from the photoconductive drums 700 are transferred directly to the paper P.

To print a color image, each color being supported can use an associated line printer head 500, developing unit 600, and photoconductive drum 700. For example, in FIG. 11, four line printer heads 500 are shown as illustrative example to each radiate light to an associated one of the four photoconductive drums 700. In each photoconductive drum 700 an electrostatic latent image corresponding to image information of one of multiple colors, for example, black (K), magenta (M), yellow (Y) and cyan (C) images, is formed. Each of four developing units 600 can supply one of black (K), magenta (M), yellow (Y), and cyan (C) toner to an associated photoconductive drum 700 to form a toner image of the appropriate color. The black (K), magenta (M), yellow (Y) and cyan (C) toner images can be transferred to the paper P either indirectly though the intermediate transferring belt 800 or directly.

Referring to FIG. 12, the line printer head 500 can have a structure associated with any of the embodiments described above with respect to FIGS. 1-10. The line printer head 500 can be configured to emit light L via openings 510 arranged in a row, and the emitted light L can form spots in a row in a main scanning direction on the photoconductive drum 700. The line printer head 500 can expose the photoconductive drum 700 according to lines produced by the linear or row arrangement of the openings 510 in the line printer head 500. As the photoconductive drum 700 rotates, a two-dimensional electrostatic latent image can be formed on the circumferential surface of the photoconductive drum 700.

While the present disclosure has been particularly shown and described with reference to several embodiments thereof, it will be understood by those of ordinary skill in the art that various changes in form and details may be made therein without departing from the spirit and scope of the present disclosure as defined by the following claims.

What is claimed is:

1. A line printer head for exposing an object across a line along a main scanning direction of an image forming apparatus, comprising:
a substrate;
a plurality of light emitting devices formed on the substrate in a linear arrangement along the main scanning direction of the image forming apparatus, each of the plurality of light emitting devices including a light emitting region configured to generate light, a first electrode disposed on a lower portion of the light emitting region, a second electrode disposed on an upper portion of the light emitting region and an optical waveguide disposed above the second electrode, the second electrode being configured to allow therethrough transmission of the light generated by the light emitting region, the optical waveguide being configured to receive the light generated by the light emitted region, and to guide the light to output through an output opening defined on the optical waveguide; and
an integrated circuit formed on the substrate to drive the plurality of light emitting devices, the integrated circuit having a plurality of output terminals, each of which being connected to the first electrode of a respective corresponding one of the plurality of light emitting devices.

2. The line printer head of claim 1, wherein the second electrodes of the plurality of light emitting devices are connected to each other form a common electrode.

3. The line printer head of claim 1, wherein the output opening of the optical waveguide is defined on an outer surface at one of an upper portion of the optical waveguide and a side portion of the optical waveguide.

4. The line printer head of claim 1, wherein the light emitting region includes an inorganic electroluminescent structure.

5. The line printer head of claim 4, wherein the inorganic electroluminescent structure is a thin film multilayer structure including a first insulation layer, an inorganic light emitting layer disposed on the first insulating layer and a second insulation layer disposed on the inorganic light emitting layer.

6. The line printer head of claim 4, wherein the integrated circuit includes circuitry made of a metal-oxide-semiconductor (MOS) process.

7. An image forming apparatus, comprising:
an object to be exposed with light;
a line printer head including a plurality of light emitting devices and an integrated circuit each formed on a substrate, the line printer head being configured to form an electrostatic latent image on the object by radiating light to the object along a main scanning direction; and
a developer unit configured to develop the electrostatic latent image into a visible toner image by supplying toner to the electrostatic latent image formed on the object,
wherein the plurality of light emitting devices are arranged in a linear arrangement corresponding to the main scanning direction, each of the plurality of light emitting devices including a light emitting region configured to generate light, a first electrode disposed on a lower portion of the light emitting region, a second electrode disposed on an upper portion of the light emitting region and an optical waveguide disposed above the second electrode, the second electrode being configured to allow therethrough transmission of the light generated by the light emitting region, the optical waveguide being configured to receive the light generated by the light emitted region, and to guide the light to output through an output opening defined on the optical waveguide, and
wherein the integrated circuit is configured to drive the plurality of light emitting devices, the integrated circuit having a plurality of output terminals, each of which being connected to the first electrode of a respective corresponding one of the plurality of light emitting devices.

8. The image forming apparatus of claim 7, wherein the second electrodes of the plurality of light emitting devices are connected to each other to form a common electrode.

9. The image forming apparatus of claim 7, wherein the output opening of the optical waveguide is defined on an outer surface at one of an upper portion of the optical waveguide and a side portion of the optical waveguide.

10. The image forming apparatus of claim 7, wherein the light emitting region includes an inorganic electroluminescent structure.

11. The image forming apparatus of claim 10, wherein the inorganic electroluminescent structure is a thin film multilayer structure including a first insulation layer, an inorganic light emitting layer disposed on the first insulating layer and a second insulation layer disposed on the inorganic light emitting layer.

12. The image forming apparatus of claim 10, wherein the integrated circuit includes circuitry made of a metal-oxide-semiconductor (MOS) process.

13. A line printer head, comprising:
a plurality of light emitting devices formed on a semiconductor substrate in a linear arrangement corresponding to a main scanning direction, each of the plurality of light emitting devices having a light emitting element, a first electrode configured to reflect light and a second electrode configured to transmit light, the light emitting element being configured to generate light in response to a current received through the first and the second electrodes, the second electrodes of the plurality of light emitting devices being connected to each other;
an integrated circuit formed on the semiconductor substrate and configured to drive the plurality of light emitting devices, the integrated circuit having a plurality of output terminals, each of which being connected to the first electrode of a respective corresponding one of the plurality of light emitting devices.

14. The line printer head of claim 13, wherein the integrated circuit is formed on the semiconductor substrate, the plurality of light emitting devices being formed on the semiconductor substrate above the integrated circuit.

15. The line printer head of claim 13, wherein each light emitting element is formed of an inorganic electroluminescent material.

16. The line printer head of claim 13, wherein each light emitting device from the plurality of light emitting devices includes an optical waveguide disposed above the second electrode, the optical waveguide being configured to receive the light generated by the light emitting element, and to guide the light toward a light exiting opening of the optical waveguide, through which the light exits the optical waveguide.

17. The line printer head of claim 16, wherein the optical waveguide comprises a transparent body formed to cover the second electrode and a reflective layer formed to cover the transparent body such that the reflective layer defines the light exiting opening.

18. The line printer head of claim 17, wherein the transparent body is formed of a photoresist selected from a group comprising SU-8, poly-methylmethacrylate (PMMA) and poly-dimethylsiloxane (PDMS).

19. The line printer head of claim 17, wherein the reflective layer is formed of aluminum.
